(19) United States
(12) Patent Application Publication
(10) Pub. No.: US 2011/0270925 A1
(43) Pub. Date: Nov. 3, 2011

(54) SYSTEM TO SHARE CREDIT INFORMATION

(76) Inventor: Magid Joseph Mina, Los Angeles, CA (US)

(21) Appl. No.: 13/096,252

(22) Filed: Apr. 28, 2011

Related U.S. Application Data
(60) Provisional application No. 61/329,015, filed on Apr. 28, 2010.

(51) Int. Cl. G06F 15/16

(52) U.S. Cl. 709/204

(57) ABSTRACT

Disclosed are methods, apparatuses, systems, and non-transitory computer-readable media associated with the use of a randomly generated reporting code unique to a party involved in a credit reporting exchange. In embodiments, once used, the reporting code may become unique to both parties (applicant and requestor) as well as the particular transaction between both parties. In embodiments, the reporting code or codes may be exchanged between the applicant and requestor, and once confirmed, credit information may be obtained by, or transmitted from, the requestor. In various embodiments, the reporting code may conceal the applicant's Social Security Number or other unique identifier(s) during the application process. If the applicant is approved for a transaction by the requestor (e.g., credit is issued), the requestor may use a reporting code to report information about the approved applicant.

### CROSS REFERENCE TO RELATED APPLICATIONS

The present application claims benefit of U.S. Provisional Application No. 61/329,015, filed Apr. 28, 2010, the entire specification of which is hereby incorporated by reference in its entirety for all purposes, except for those sections, if any, that are inconsistent with this specification.

### TECHNICAL FIELD

Embodiments of the present invention relate to systems and methods for obtaining an applicant's credit information and reporting credit information on an approved applicant to credit bureaus or other appropriate agencies without the applicant providing sensitive identifier(s) to a party who is a requestor of the credit information.

### BACKGROUND

Identity and account theft has become so prevalent that an entire industry has evolved to provide insurance against and prevent this type of theft. One way to mitigate this theft is for applicants to avoid giving out their Social Security Numbers or other unique identifier(s) when a creditor, employer, landlord or any other credit information requestor is obtaining the applicant's credit information. Existing techniques do not allow requestors to obtain or report credit information without these unique identifiers.

An online, mobile and/or other system or method that can provide credit information without also sharing an applicant's Social Security Number or other unique identifier(s) is needed.

### BRIEF DESCRIPTION OF THE DRAWINGS

Embodiments of the present invention will be readily understood by the following detailed description in conjunction with the accompanying drawings and flow charts. Embodiments of the invention are illustrated by way of example and not by way of limitation in the figures of the accompanying drawings.

FIG. 1 is a flowchart illustrating exemplary account activation processes in accordance with various embodiments.

FIGS. 2A, 2B and 2C are flowcharts illustrating exemplary methods by which a credit report requestor may obtain an applicant's credit report in accordance with various embodiments.

FIG. 3 is a flowchart illustrating exemplary method by which a requestor may report the applicant's credit information to credit bureaus or agencies after the applicant and the requestor have entered into a business transaction in accordance with various embodiments.

FIG. 4 is a block diagram illustrating entities utilizing credit information sharing systems and techniques as well as information flows between the entitles in accordance with various embodiments.

FIG. 5 is a block diagram illustrating an example computing environment in accordance with various embodiments.

FIGS. 6-10 are example screen shots of implementations of user interfaces for interacting with the systems and techniques described herein in accordance with various embodiments.

### DETAILED DESCRIPTION OF EMBODIMENTS

In the following detailed description, reference is made to the accompanying drawings which form a part hereof, and in which are shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scopes of embodiments, in accordance with the present disclosure, are defined by the appended claims and their equivalents.

Various operations may be described as multiple discrete operations in turn, in a manner that may be helpful in understanding embodiments of the present invention; however, the order of description should not be construed to imply that these operations are order dependent.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the phrases “in an embodiment,” or “in embodiments,” which may each refer to one or more of the same or different embodiments. The description may also use the phrases “in an implementation,” or “in an alternative implementation,” which may each refer to one or more of the same or different implementation details of various embodiments described herein. Furthermore, the terms “comprising,” “including,” “having,” and the like, as used with respect to embodiments or implementations of the present invention, are synonymous. The term “exemplary” as used herein merely illustrates that an example is being shown or described and is not intended to denote that any so-described feature is preferred or required over any other. Additionally, while flowcharts and descriptions of processes may make reference to particular steps, it should be understood that, in alternative implementations, the illustrated steps may be combined or divided into two or more sub-steps.

Various embodiments and implementations of the present invention may include online, mobile and/or other systems or methods that conceal an applicant's Social Security Number or unique identifier(s) when a requestor is obtaining or reporting credit information, such as from/to credit bureaus or other applicable agencies. In various embodiments, the unique applicant credit information is protected so as to help prevent fraud that could emanate from unintended sharing of the information exchanged. Embodiments of the present invention may facilitate transactions between an applicant (e.g. a potential borrower, employee, tenant, or anyone on whom a requestor seeks or reports credit information) and a credit information requestor (e.g., a lender, creditor, employer, landlord, etc.).

In various embodiments, a system may use, for example, a randomly generated, temporary, single use, reporting code unique to one of the parties involved in a credit reporting exchange. Once used, the reporting code may become unique to both parties (applicant and requestor) as well as the particular transaction between both parties. The reporting code or codes may be exchanged between the applicant and requestor, and once confirmed, credit information may be obtained by, or transmitted from, the requestor. In various embodiments, one function of the reporting code is to conceal the applicant's Social Security Number or other unique identifier(s) during the application process. If the applicant is approved for a transaction by the requestor (e.g., credit is issued), the requestor may use a reporting code to report information about the approved applicant to credit bureaus or other appropriate agencies, such as during a credit period (e.g. a 5-year car loan). In some embodiments, another reporting code could be issued for reporting information if an applicant is approved for a transaction, while the first reporting code may be a single use code and temporarily used only initially to obtain the applicant's credit information. In some embodiments, if the applicant is declined, the reporting code will expire. Thus, the reporting code can be temporary or single use (if a credit report is not obtained or credit is not granted) or used repeatedly for one specific credit transaction (e.g. to report to credit bureaus on monthly basis for the term of a 5-year car loan). Although this system may be applied to various credit transactions, this document illustrates two types of transactions in particular: (1) applicant-generated reporting code transactions—in which the reporting code is generated by the applicant and given to the requestor and (2) requestor-generated reporting code transactions—in which the reporting code is generated by the requestor and given to the applicant.

### 1. Examples of Account Set Up

In various embodiments, before an applicant or requestor uses the system, they must set up an account with a service provider; in various embodiments the service provider may be an independent party, a credit bureau, or credit reporting agency. If the service provider is a credit bureau or credit reporting agency, the requestor may already have an existing account with the service provider. Setting up an account may include providing necessary information to the service provider to allow the service provider to make a unique account for the applicant or requestor. Once verified, the applicant's or requestor's chosen account name, number or other unique account identifier is activated.

An example list of information that may be provided by the applicant in setting up an account may include, but is not limited to, one or more of the following:
First Name
Middle Name (initial)
Last Name
Suffix
Street Address
City, State, Zip (or as appropriate for country)
Country
Social Security Number (SSN) or other unique identifier(s)
Birth Date
One or more bank account # (s)
One or more credit card # (s)
Credit card expiration date(s)
Credit card security code(s)
Names on credit card(s)
Billing Addresses for credit card(s)
Email address(es)
Sign-In Screen Artwork
User Name
Password
PIN
Answers to one or more security question(s)
One or more phone number(s)
Preferences relating to receiving reporting codes (e.g., via email, text message, or both)

In various embodiments, a service provider may use the information above to verify the applicant's identity and verify that the Social Security Number, credit card number(s), account number(s), etc, are not already being used by another user on the system and/or are properly linked to the identified applicant.

An example list of information that may be provided by a requestor in setting up an account may include, but is not limited to, some or all of the following:

Company Name

Corporate Address

City, State, Zip (or as appropriate for country)

Country

Corporate Phone Number

Tax ID Number or other unique identifier

One or more corporate bank account number(s)

Contact Person

Contact Person's Street Address

Contact Person's City, State, Zip (or as appropriate for country)

Contact Person's Country

Contact Person's Phone Number

Contact Person's Cell Phone Number

Contact Person's Email

Corporate User Name

Corporate Password

Answers to one or more security question(s)

In various embodiments, the service provider may use the information above to verify the requestor's information and verify that the Tax ID Number or other unique identifier and other information are not already being used by another requestor account on the system and/or are properly linked to the verified requestor.

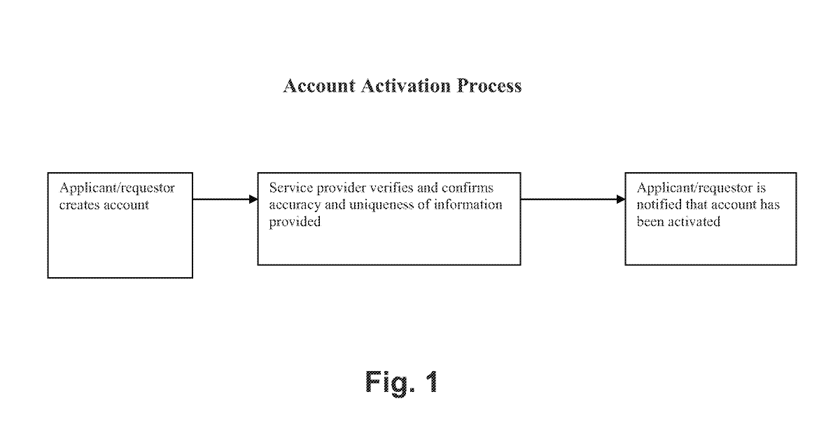

FIG. 1 illustrates an example embodiment of an applicant (or requestor's) account activation and set up process. For example, the process begins where the applicant or requestor creates an account; this may include providing of information such as the examples described above. Next, the service provider verifies and confirms the accuracy and uniqueness of the information provided by the applicant or the requestor. Next, the applicant or requestor is notified that an account has been activated.

### 2. Examples of Applicant-Generated Reporting Codes

In various embodiments, upon or prior to a requestor requesting an applicant's credit report, the applicant may log into his/her account and obtain an applicant reporting code. In various embodiments, the applicant reporting code may be set to expire after a period specified by the applicant (e.g. 2 days) or if the requestor declines the applicant's application, whichever occurs first. In various embodiments, reporting codes are limited to a single-use, in order to increase the security of the codes. However, in alternative embodiments, an applicant may be provided optional multi-use codes which can be used more than one time and/or up to a limited number of times. These multi-use codes may be limited to a single requestor or permitted for multiple requestors. In various embodiments, the applicant reporting code may be sent from the service provider to the applicant by email, text message, etc. In other embodiments, the applicant reporting code may be displayed, such as on a screen in a browser or other application window, for the applicant to copy as he or she desires.

The following is an example data collection interface that an applicant may encounter in order to generate an applicant reporting code:

Website—Applicant Code Generation Screen
1. User Name request
2. A screen appears with the user's “Sign-In Screen Artwork” to let the user know he/she is logging into the system and not some screen generated by hacker wishing to obtain the user's login information
3. Password request
4. Request for maximum time for reporting code to remain active (Example: 7 days)
5. An applicant reporting code is generated by the system and displayed and/or sent to the applicant

In various embodiments, reporting codes generated by the system after the applicant inputs the above information include various alphabetic, numeric, alphanumeric, or other character strings. For example, in various embodiments reporting codes may include AB3-S2-34RD, B53EX2Z39, 190ZZ256FG9PRZ. In various embodiments, reporting codes may vary in length (i.e. the total number of digits and characters), making them more difficult to guess than codes with a preset fixed length. In various embodiments, the generation screen could also provide an optional selection for an amount or degree of credit information to provide? In some embodiments, for example, an applicant may generate one reporting code that provides a full report for a first requestor, and generate a reporting code for a second requestor that provides a circumscribed report. One example of a circumscribed report may be a report which contains only rental history, such as might be provided to a potential lessor.

In various embodiments, after generation, the applicant reporting code may be given to the requestor by the applicant. The requestor then gives the applicant reporting code to the service provider to obtain the applicant's credit report. The following is an example data collection interface that a requestor may encounter in using the reporting code provided by the applicant to obtain the applicant's credit report:

Website—Requestor Credit Report Generation Screen

1. User Name request

2. A screen appears with the user's “Sign-In Screen Artwork”

3. Password request

4. Request for reporting code provided by applicant

5. Request for confirmation of the applicant's name

In various embodiments, the applicant's credit report may be sent to the requestor as a standalone file (e.g. PDF), as an addition to a database or by other appropriate methods. The credit report may be sent in an email, through a batch process, on a display, or by other appropriate methods or protocols.

In various embodiments, the credit report would not contain the applicant's Social Security Number or other unique identifier(s), but may contain the reporting code, so the report could be uniquely identified, and may otherwise conform to standard credit reporting formats.

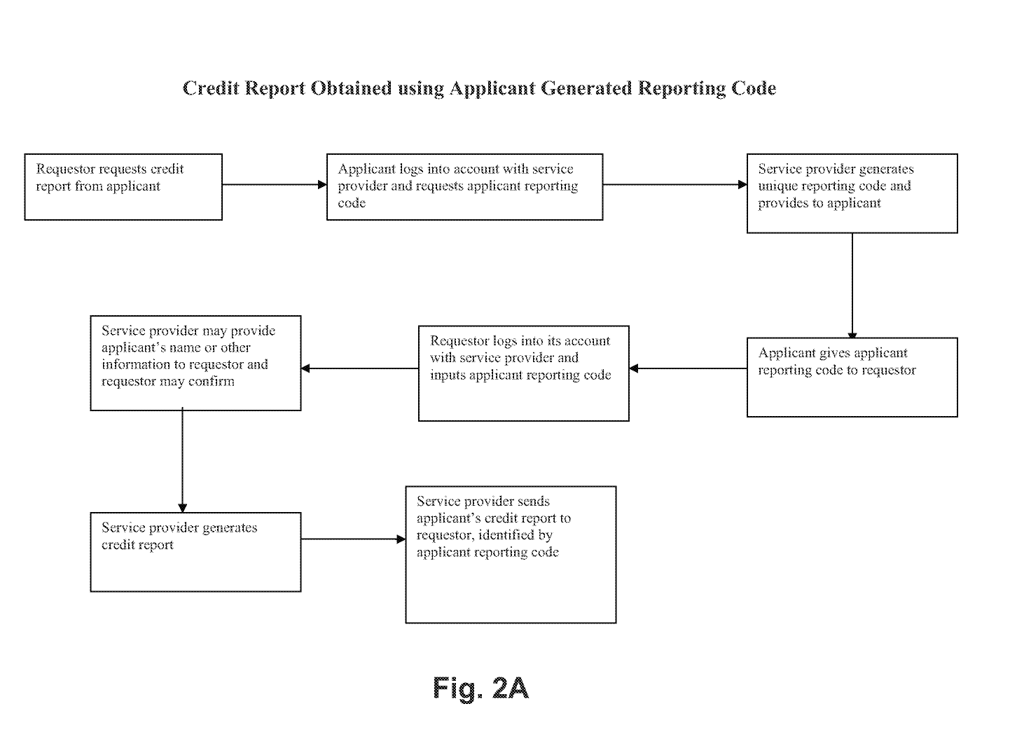

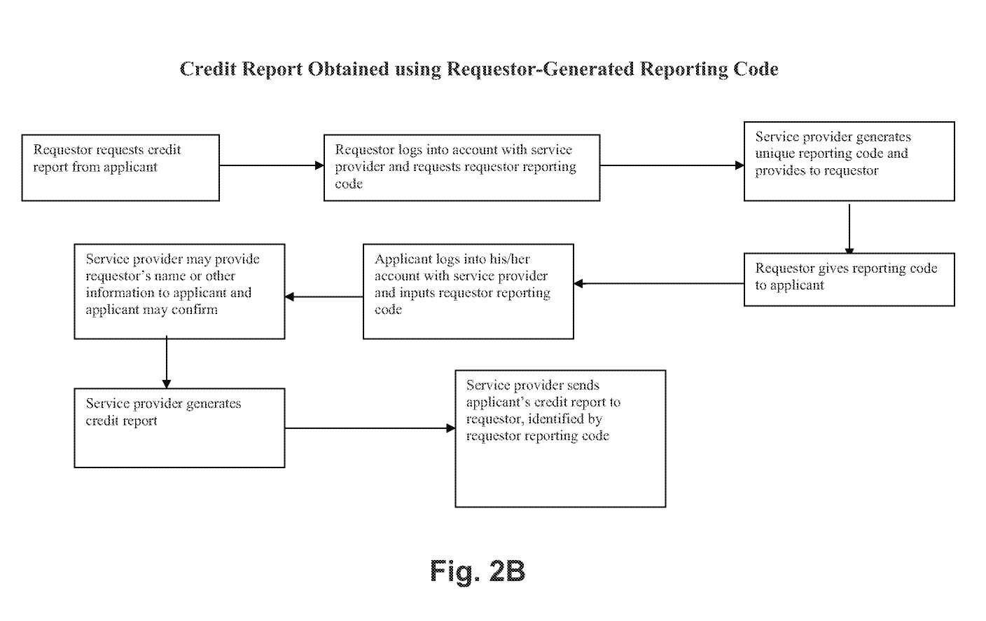

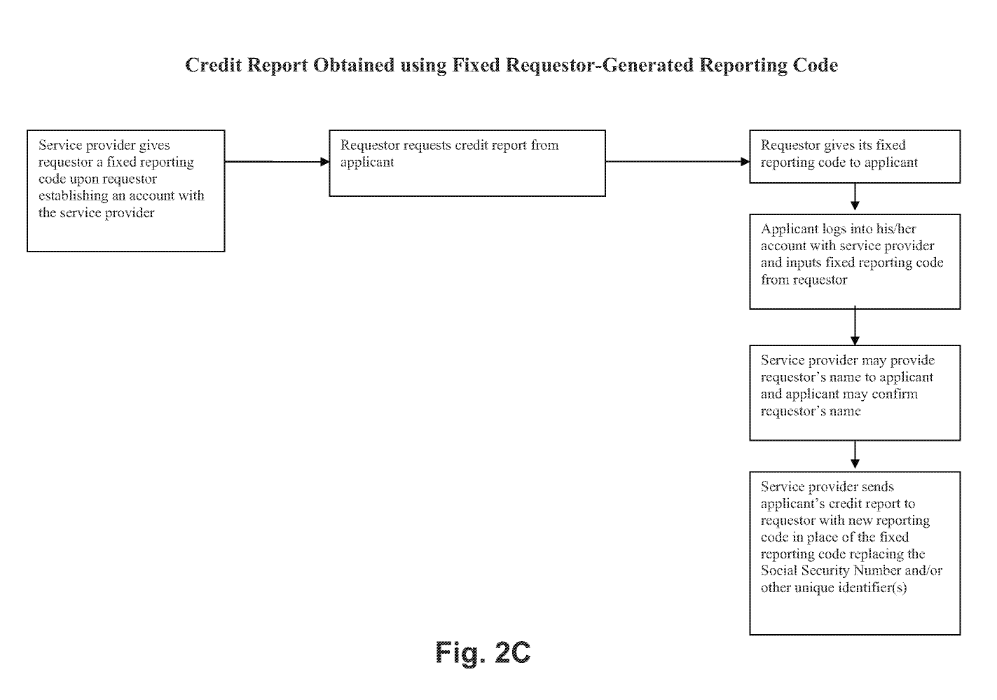

FIG. 2A illustrates an example embodiment of a process for a requestor to obtain an applicant's credit report using an applicant reporting code. For example, the process begins where a requestor requests a credit report from an applicant. Next, the applicant may log into his or her account with the service provider and request an applicant reporting code. Next, the service provider generates a unique applicant reporting code and provides the code to the applicant. The applicant then provides the applicant reporting code to the requestor. The requestor then logs into its account with the service provider and inputs the applicant reporting code. The service provider may then provide the applicants name (or some other identifier of the applicant) to the requestor to confirm that the requestor is requesting a credit report from the correct applicant. Next, the service provider may generate a credit report and send this credit report to the requestor. As discussed above, the credit report may be identified by the applicant reporting code.

### 3. Examples of Requestor-Generated Reporting Codes

In various embodiments, upon, or prior to, the requestor requesting to obtain an applicant's credit report, the requestor may log into its account and obtain a requestor reporting code. In various embodiments, the reporting code may be set to expire after a period specified by the requestor (e.g. 2 days) or, if the requestor declines the applicant's application, whichever occurs first. In various embodiments, the reporting code may be sent from the service provider to the requestor by sending it to a database, by displaying it on a screen, by email, text message, or by other appropriate method(s).

The following is an example data collection interface that a requestor may encounter in order to generate a requestor reporting code:

Website—Requestor Code Generation Screen
1. User Name request
2. A screen appears with the user's “Sign-In Screen Artwork” to let the user know he/she is logging into the system and not some screen generated by hacker wishing to obtain the user's login information
3. Password request
4. Request for maximum time for reporting code to remain active (Example: 7 days)
5. A requestor reporting code is generated by the system and displayed or sent to the requestor

As discussed above, in various embodiments, reporting codes generated by the system after the applicant inputs the above information include various alphabetic, numeric, alphanumeric, or other character strings. For example, in various embodiments reporting codes may include AB3-S2-34RD, B53EX2Z39, 190ZZ256FG9PRZ. In various embodiments, reporting codes may vary in length (i.e. the total number of digits and characters), making them more difficult to guess than codes with a preset fixed length.

In various embodiments, after generation the requestor reporting code is given to the applicant by the requestor. The applicant then gives the requestor reporting code to the service provider, allowing the service provider to send the applicant's credit report to the requestor. The following is an example data collection interface that an applicant may encounter in using the requestor reporting code to allow the service provider to send the requestor the applicant's credit report:

Website—Applicant Credit Report Generation Screen

1. User Name request

2. A screen appears with the user's “Sign-In Screen Artwork”

3. Password request

4. Request for reporting code provided by requestor

5. Request for confirmation of the requestor name to receive credit report

In various embodiments, the applicant's credit report may be sent to the requestor as a standalone file (e.g. PDF), as an addition to a database or by other appropriate methods. The credit report may be sent in an email, through a batch process, on a display, or by other appropriate methods or protocols.

In various embodiments, the credit report would not contain the applicant's Social Security Number or other unique identifiers(s), but may contain the requestor reporting code, so the credit report could be uniquely identified, and may otherwise conform to standard credit reporting formats.

FIG. 2B illustrates an example embodiment of a process for a requestor to obtain an applicant's credit report using a requestor reporting code. For example, the requestor requests a credit report from the applicant. Next, the requestor logs into the service provider and requests a requestor reporting code. The service provider generates the requestor reporting code and provides this to the requestor. Next, the requestor gives the code to the applicant, who logs into his or her account with the service provider and inputs the requestor reporting code. The service provider may then provide the requestor's name (or some other identifier of the requestor) to the applicant to confirm that the applicant is generating a credit report for the correct requestor. Next, the service provider may generate a credit report and send this credit report to the requestor. As discussed above, the credit report may be identified by the requestor reporting code.

In various alternative embodiments, a non-temporary, or “fixed,” requestor reporting code may be generated by the service provider and assigned to a requestor. The requestor may then give its fixed requestor reporting code to each applicant from whom it is requesting credit information. Later, when an applicant gives a fixed reporting code to a service provider to allow the service provider to send his/her credit report to the requestor, the service provider may then generate a unique reporting code and provide it with the applicant's credit report being sent to the requestor. These alternative embodiments may provide increased efficiency in various scenarios, such as a requestor that needs to obtain a large volume of credit reports.

FIG. 2C illustrates an alternative embodiment of a requestor obtaining the applicant's credit report using a requestor-generated reporting code. For example, a service provider may provide a fixed reporting code upon a requestor establishing an account. Next, the requestor may request a credit report from the applicant and give its fixed reporting code to the applicant. Once the applicant logs into the service provider and provides the fixed reporting code, the service provider may then ask the applicant to confirm information about the requestor and then send the applicant's credit report to the requestor along with a new reporting code (or other identifier) instead of the applicant's Social Security Number or other unique identifier(s).

### 4. Examples of Credit Reporting to Credit Bureaus or Agencies

In various embodiments, once an applicant is approved and has established a relationship with a requestor, the requestor may choose (or be required, such as by law) to report credit information about the approved applicant to credit bureaus or agencies.

In various embodiments, the requestor may report the credit information to the service provider using a reporting code as an identifier for the applicant on whom the requestor is reporting. In some embodiments, the reporting may otherwise be performed in the same manner in which creditors normally report such information to credit bureaus or agencies. In various embodiments, the reporting code (or codes) would be shown in place of an applicant's Social Security Number and/or other unique identifier(s). The service provider may then substitute the applicant's Social Security Number and/or other unique identifier(s) for the reporting code and forward the information to the credit bureaus or agencies. Thus, the information received by the credit bureaus or agencies would be the same or similar as it would otherwise have been if the requestor had been in possession of the applicant's Social Security Number and/or other unique identifier(s).

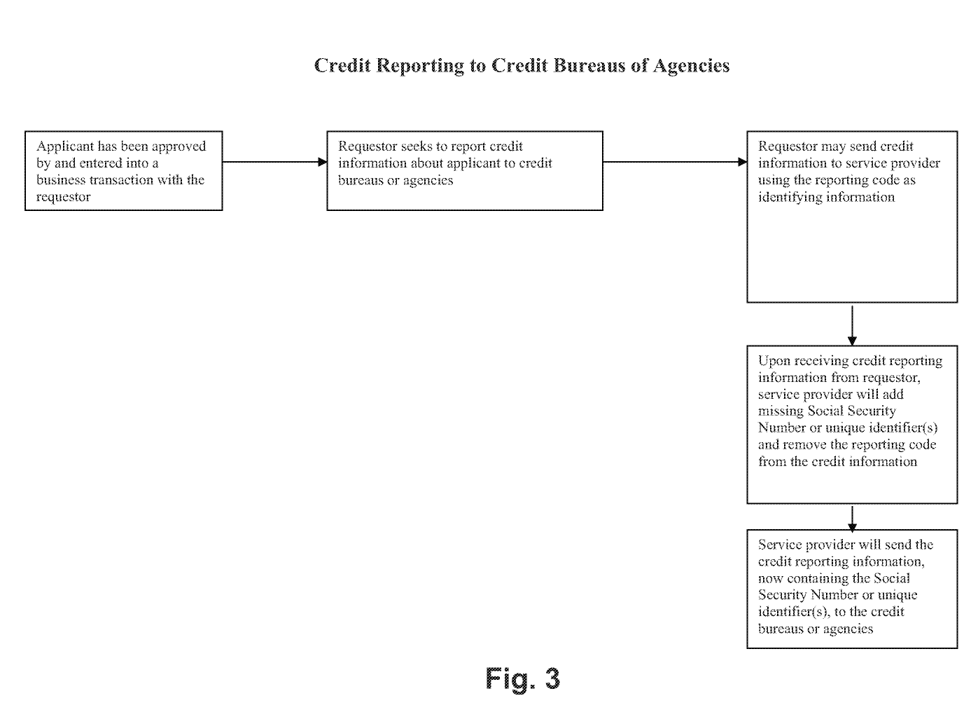

FIG. 3 illustrates an example embodiment of a requestor reporting credit information about an applicant to credit bureaus or agencies. For example, after an applicant has been approved by and has entered into a business transaction with a requestor, the requestor may seek to report credit information about the applicant to one or more credit bureaus or agencies. The requestor may then send this credit information to a service provider using the reporting code as identifying information. Then, after receiving the credit information from the requestor, the service provider will add any missing information, such as a Social Security Number or other unique identifier(s) and may remove the reporting code from the credit information. The service provider may then send the credit information, including the Social Security Number or other unique identifier(s) to one or more credit bureaus or agencies.

### 5. Examples of Information Flows and Relationships

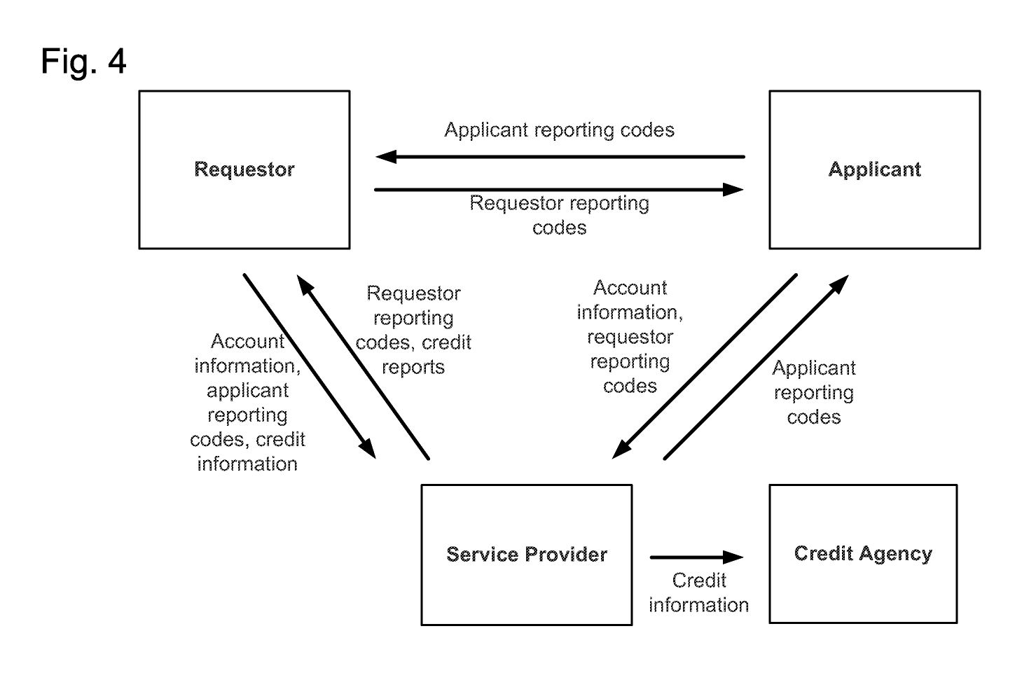

FIG. 4 is a box diagram illustrating information flows and relationships between entities utilizing the credit reporting techniques described herein. As FIG. 4 illustrates, Applicants and requestors may, in various embodiments, communicate by sharing reporting codes with each other, such as was described above. Applicants and requestors may also perform additional communication in the form of financial and other transactions in the scope of their business or other relationship; these are not illustrated for the sake of clearer illustration. The requestor and applicant, in turn may also communicate with a service provider, as described above. For example in various embodiments, a requestor may provide account information, applicant reporting codes, and/or credit information to the service provider, while the applicant may provide account information and/or requestor reporting codes to the service provider. The service provider may, in various embodiments, provide reporting codes to the requestor or the applicant, as well as credit reports to the requestor. Additionally, in various embodiments, the service provider may provide credit information, such as that provided to the service provider from the requestor, to one or more credit agencies.

### 6. Example of Computing Environment

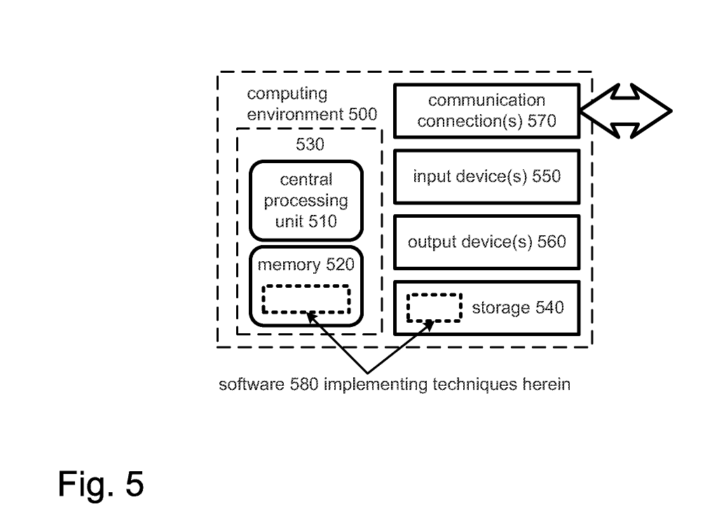

FIG. 5 illustrates a generalized example of a suitable computing environment (500) in which several of the described embodiments may be implemented. The computing environment (500) is not intended to suggest any limitation as to scope of use or functionality, as the techniques and tools may be implemented in diverse general-purpose or special-purpose computing environments such as personal computers, consumer electronic devices, mobile devices, networked computers, and the like.

With reference to FIG. 5, the computing environment (500) includes at least one CPU (510) and associated memory (520). In FIG. 5, this most basic configuration (530) is included within a dashed line. The processing unit (510) executes computer-executable instructions and may be a real or a virtual processor. In a multi-processing system, multiple processing units execute computer-executable instructions to increase processing power. In some implementations, these operations may be computationally intensive operations (e.g., fractional sample interpolation for motion compensation, in-loop deblock filtering). In others, entire sub-processes of the general decoding process may be performed by hardware acceleration (e.g., variable-length decoding, inverse transform decoding, motion compensation). The memory (520) may be volatile memory (e.g., registers, cache, RAM), non-volatile memory (e.g., ROM, EEPROM, flash memory, etc.), or some combination of the two. The memory (520) stores software (580) implementing the techniques described herein.

A computing environment may have additional features. For example, the computing environment (500) includes storage (540), one or more input devices (550), one or more output devices (560), and one or more communication connections (570). An interconnection mechanism (not shown) such as a bus, controller, or network interconnects the components of the computing environment (500). Typically, operating system software (not shown) provides an operating environment for other software executing in the computing environment (500), and coordinates activities of the components of the computing environment (500).

The storage (540) may be removable or non-removable, and includes magnetic disks, magnetic tapes or cassettes, CD-ROMs, DVDs, flash drives, disk arrays, or any other medium which can be used to store information and which can be accessed within the computing environment (500). The storage (540) stores instructions for the software.

The input device(s) (550) may be a touch input device such as a keyboard, mouse, pen, or trackball, a voice input device, a scanning device, or another device that provides input to the computing environment (500). For audio or video encoding, the input device(s) (550) may be a sound card, video card, TV tuner card, or similar device that accepts audio or video input in analog or digital form, or a CD- or DVD-based drive that reads audio or video samples into the computing environment (500). The output device(s) (560) may be a display (e.g., monitor, display screen, or the like), printer, speaker, DVD-writer, or another device that provides output from the computing environment (500).

The communication connection(s) (570) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier. In various embodiments, multiple computing entities may operate in coordination to provide the services described herein, with individual entities performing all or part of the techniques and services. The communication described herein may be utilized to coordinate the provision of these services, such as over a network.

The techniques and tools can be described in the general context of computer-readable media. Computer-readable media are any available media that can be accessed within a computing environment. By way of example, and not limitation, with the computing environment (500), computer-readable media include memory (520), computer-readable storage media (540) (e.g., CDs, DVDs, diskettes, flash drives, removable hard drives, hard drive arrays), and combinations of any of the above.

The techniques and tools can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description may uses terms like “generate,” “provide,” and “send” to describe computer operations in a computing environment. These terms are high-level abstractions for operations performed by a computer, and should not be confused with acts performed by a human being. The actual computer operations corresponding to these terms vary depending on implementation.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present embodiments be limited only by claims and equivalents thereof

### 5. Example Interfaces

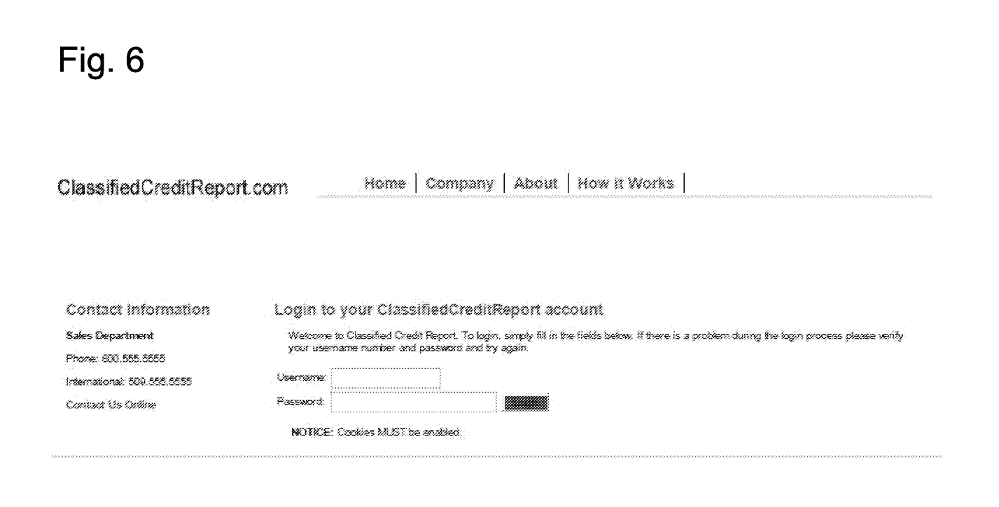

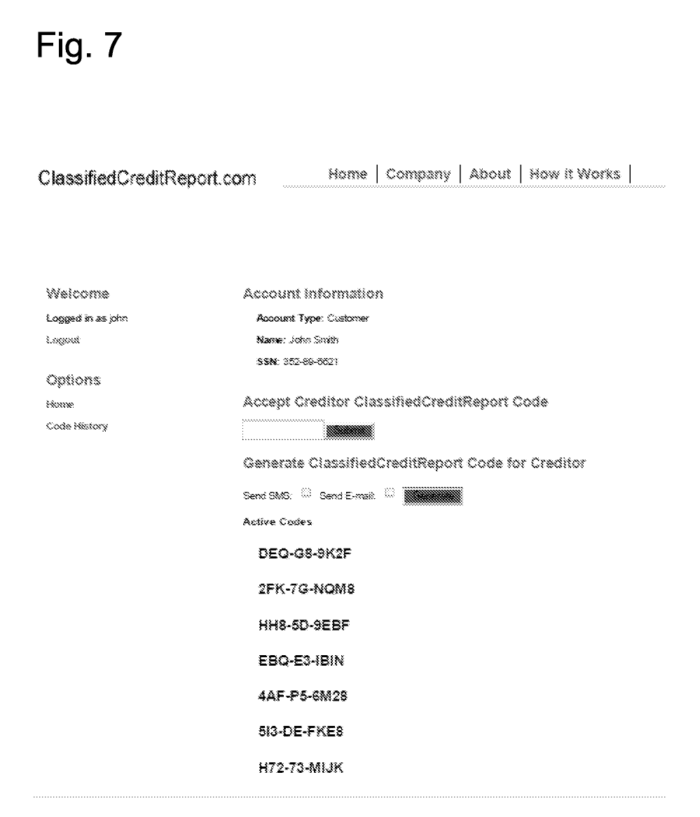

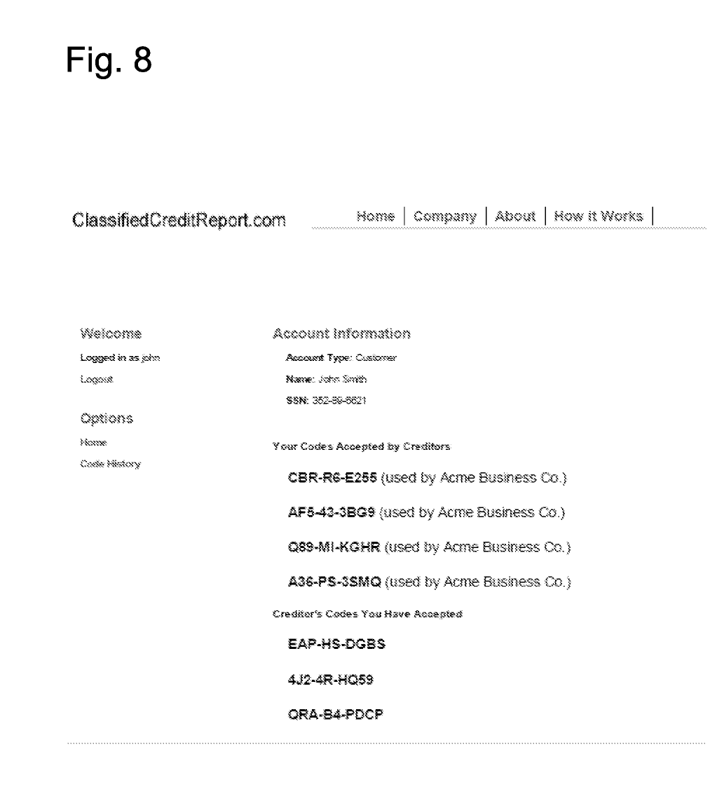

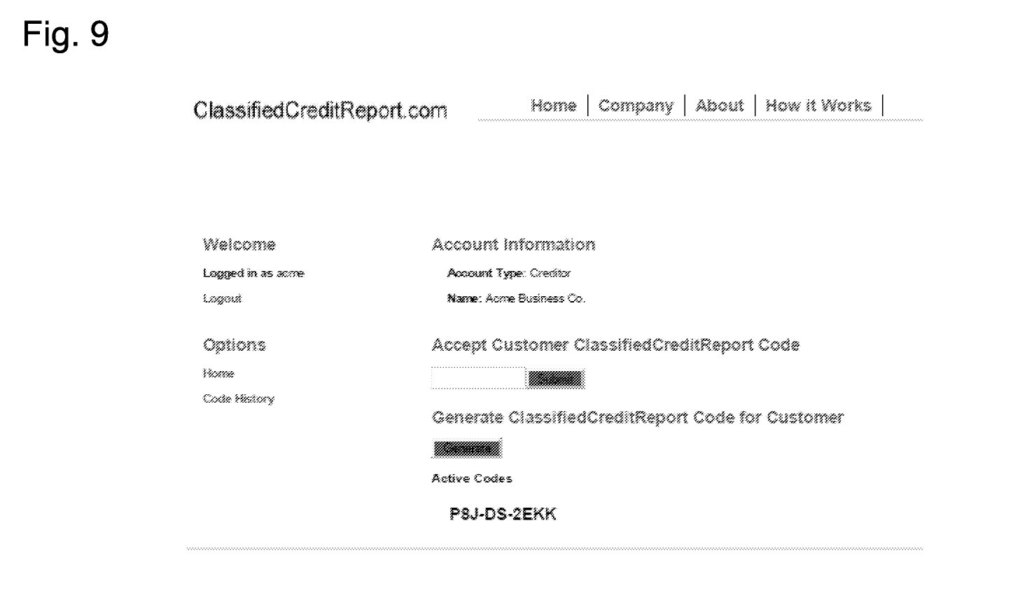

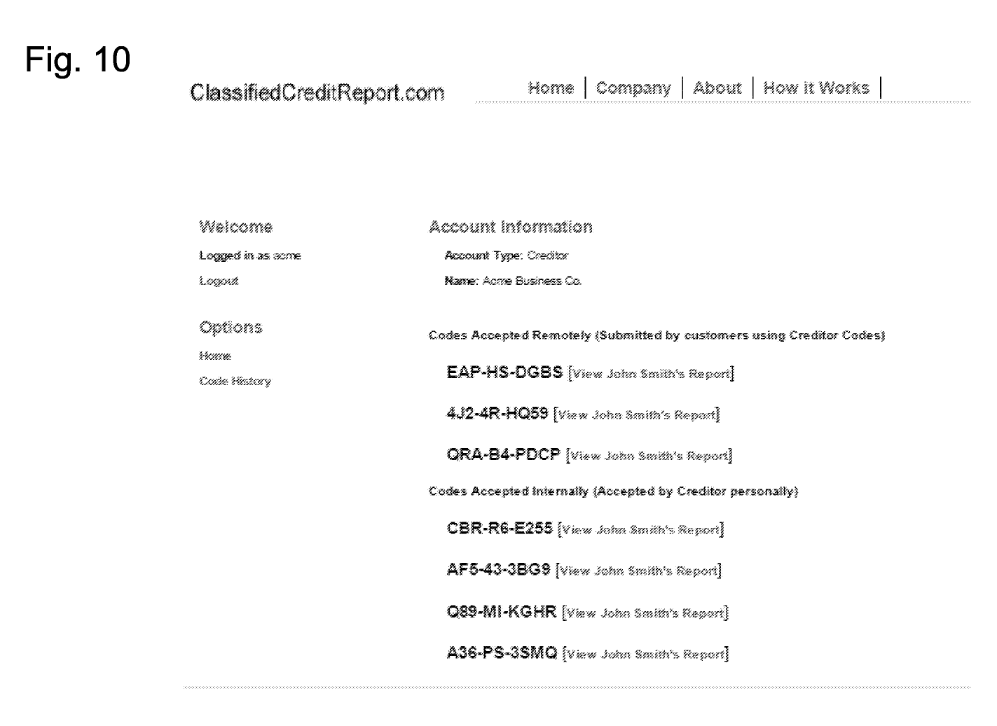

FIGS. 6-10 are example screen shots of implementations of user interfaces for interacting with the systems and techniques described herein in accordance with various embodiments. The examples of FIGS. 6-10 are offered by way of illustration only and should not imply any particular limitations or requirements of any particular embodiments described herein. FIG. 6 illustrates an example log in screen. FIG. 7 illustrates an example applicant reporting code generation screen. FIG. 8 illustrates an example applicant reporting code history screen. FIG. 9 illustrates an example requestor reporting code generation screen. FIG. 10 illustrates an example requestor reporting code history screen.

What is claimed is:

1. A computer-implemented method for facilitating sharing of credit information, the method comprising:
generating, by the computing device, a reporting code which is associated with a first party;
sending, by the computing device, the reporting code to the first party;
receiving, from a second party, by the computing device, the reporting code; and
sending, by the computing device, financial information associated with the first party to the second party.
